(19) United States
(12) Patent Application Publication
(10) Pub. No.: US 2009/0264156 A1
(43) Pub. Date: Oct. 22, 2009

(54) Foldable cellular phone device

(76) Inventors: Gunther Burghardt, Bochum (DE); Ralf Syldatke, Dortmund (DE); Anton Fahlgren, Copenhagen (DK); Chee Wong, Oulu (FI)

Correspondence Address: Locke Lord Bissell & Liddell LLP;Attn: IP Docketing, Three World Financial Center, New York, NY, 10281-2101, US

(21) Appl. No.: 11/663,241

(22) PCT Filed: Sep. 20, 2004
(86) PCT No.: PCT/IB04/03052

§ 371 Date: Jun. 10, 2009

(51) Int. Cl. H04B 1/38; H04M 1/00

(52) U.S. Cl. 455/566; 455/575.3

(57) ABSTRACT

The invention relates to a foldable cellular phone device with a cellular phone component, provided with an earpiece, said foldable cellular phone device comprising a housing having a first housing element, having first and second faces; and a second housing element having third and fourth faces, wherein a first user interface is mounted within said first housing element and is accessible on said first face; wherein a second user interface is mounted within said second housing element and is accessible on said third face; wherein said first housing element and said second housing element are coupled together by a swivel hinge, such that said first housing element and said second housing element can rotate about a first axis of said swivel hinge between a first closed position and a first open position, wherein in said first closed position said first housing element and said second housing element are folded together such that the first face and said third face are conformingly adjacent to each other enclosing said first user interface and said second user interface between said first housing element and said second housing element, and wherein in said first open position said first housing element and said second housing element are folded open with said first and said second housing elements being angularly displaced about said first axis from said first closed position to an angle between 90 and 180 degrees such that said first and said third face are arranged oppositely, wherein said swivel hinge further couples said first housing element and said second housing element such that said first housing element can rotate about a second axis of said swivel hinge perpendicular to said first axis between a first rotation position and a second rotation position of said first housing element, as defined relative to said second housing element, wherein in said first open position and said first closed position said first element is in said first rotation position, and wherein said foldable cellular phone device further comprises a second open position and a second closed position, wherein said first element is in said second rotation position, wherein in said second open position said first housing element and said second housing element are folded open with said first and said second housing elements being angularly displaced about said first axis from said first closed position to an angle between 90 and 180 degrees such that said such that said second and said third face are arranged oppositely, and wherein in said second closed position said first housing element and said second housing element are folded together such that the second face and said third face are conformingly adjacent to each other, such that said first user interface is accessible on an outer side of said foldable cellular phone device. Said earpiece is arranged in said second housing element wherein a sound outlet of said earpiece is located at said third face, said first housing element is provided with a soundhole, wherein said soundhole is arranged such that in said second closed position said sound hole is located oppositely to said sound outlet of said earpiece in said second housing element such that an audio signal generated by said earpiece is transmitted through said first housing element.

The present invention relates to foldable electronic devices such as known from foldable palmtop computers and foldable cellular telephones. Particularly the present invention relates to “multi-hinge” clamshell telephone multifunctional devices such as “lap/palmtops” that can be converted to “tablet-PCs”. More specifically the invention relates to clamshell devices with a cover element that can be turned over, such as known e.g. from foldable cellular telephones. More specifically the present invention relates to a flipover clamshell cellular game phone with a touch screen display and a game input interface. The present invention also relates to clamshell type game phones. The present invention also relates to a new way to arrange loudspeakers and earpieces on such electronic telephone devices.

Conventional portable game devices are known from actually available portable game devices with a display and a game input interface. Known game devices can have principally the form of a general brick, wherein the display and the input interfaces are located on one side of the rectangular parallelepiped form of the gaming device. Enhanced versions of known gaming devices are also provided with “shoulder keys” on the “top side” to provide additional input operability. Actually there are also foldable gaming devices available. Foldable configurations of gaming devices usually employ a foldable display element that can be closed or opened over a main body element that is provided with game input interface elements such as e.g. joysticks, joypads and action keys.

A conventional multi-foldable communication device is e.g. known from the U.S. Pat. No. 6,549,789 “foldable electronic device with an adaptable user interface” assigned to Motorola Inc. filed on Apr. 28, 2000. The known state of the art electronic devices and cellular telephones have to be opened for a telephone operation. In the telephones the microphone is usually arranged in the body of the device and the earpiece is arranged in the cover element on top. In the case of an incoming telephone call the mobile phone has to be unfolded into this open position, wherein the microphone and the earpiece are arranged oppositely as in the case of a conventional handset. At present it is not possible to take an incoming phone call with a foldable phone in the closed position. The phone of U.S. Pat. No. 6,549,789 is a foldable phone that can only be used for telephony while the display is open.

All the above approaches of flip phones and gaming devices have in common that they are not suitable for use with mobile terminal devices such as game enabled mobile phones. Actually there are no clamshell phone devices on the market that require an ability to take incoming phone calls in different closed configurations.

The earpiece has to be at the topside of the device. If the earpiece is placed within the flipable display unit, the earpiece would flip from one side to the other, depending on the mode or the position of the “flip-swivel” display. For this solution the earpiece would require two sound outlets, each one besides the display unit. In addition to that the microphone would need to be placed in the display as well to keep the required distance to the earpiece. In this case the audio signals have to be rerouted for microphone and earpiece through the hinge, resulting in extra cabling and insulation risks.

It is therefore desirable to have a cellular telephone gaming device that is capable of providing enhanced gaming experience and full telephone operability. Conventional designs of foldable telephones and of portable gaming devices can not provide a suitable telephone gaming solution, as clamshell devices are not suitable for any kind of telephone operation. The conventional solution of clamshell type telephones requires a telephone interface usually located on the “backside” of the display element, as known from the Nokia communicator device. This kind of devices can only be used in the closed position for telephone operation.

It is therefore desirable to have a solution for enabling a user to take an incoming telephone call in both closed positions of a “flip-swivel” cover electronic device with a normally closed device and with a device with “flipped” cover element in the closed position.

Other flip or swivel housing electronic devices are e.g. the Nintendo Game boy advance SP or e.g. Sony Clié flip-Personal Digital Assistant (PDA). All these devices provide either gaming functionality or PDA functionality, but can not provide any kind of telephone operability.

It is also desirable to have a special earpiece solution for an electronic game device with an integrated mobile phone, wherein the device has a large display with a touch pad wherein the display unit could be used in different ways:
in a PDA mode, wherein the display is outside and the unit is closed,
in a “laptop” or “game” mode, wherein the display is inside, and the unit is folded open, and
in a protected mode, wherein the display is inside (not visible) and the unit is closed.

It is desirable to enhance the concept of mobile terminal supporting enhanced game functionality and mobile phone functionality.

A mobile terminal is desired which provides a user interface for gaming, including e.g. joysticks, a large display and other functionality for gaming and on the other hand the terminal shall support phone functionality which usually requires an ITU-T keypad at least. The problem is to design a terminal with this functionality, which supports all these different applications in the best way.

According to a first aspect of the present invention there is provided a foldable cellular phone device with a cellular phone component having an earpiece. Said foldable cellular phone device is provided with a housing having a first and a second element connected or articulated via a flip-swivel hinge. The first housing element has a first and a second face. The second housing element has a third and a fourth face. A first user interface is mounted within said first housing element and is accessible on said first face. A second user interface is mounted within said second housing element and is accessible on said third face. Said first housing element and said second housing element are coupled together by a swivel hinge, such that said first housing element and said second housing element can rotate about a first axis of said swivel hinge between a first closed position and a first open position.

In said first closed position said first housing element and said second housing element are folded together such that the first face and said third face are conformingly adjacent to each other enclosing said first user interface and said second user interface in-between said first housing element and said second housing element.

In said first open position said first housing element and said second housing element are folded open with said first and said second housing elements being angularly displaced about said first axis from said first closed position to an angle between 90 and 180 degrees such that said first and said third face are arranged oppositely. In the first open position the first and second user interfaces are arranged as the inner sides of covers of an open book, facing each other.

Said swivel hinge further couples said first housing element and said second housing element such that said first housing element can rotate about a second axis of said swivel hinge perpendicular to said first axis. The first housing element can be rotated between a first rotation position and a second rotation position, relative to said second housing element.

In said first open position and said first closed position said first element is in said first rotation position.

Said foldable cellular phone device further comprises a second open position and a second closed position, wherein said first element is in said second rotation position.

In said second open position said first housing element and said second housing element are folded open with said first and said second housing elements being angularly displaced about said first axis from said first closed position to an angle between 90 and 180 degrees such that said second and said third face are arranged oppositely. In the second open position said first and second user interfaces are facing in the same rotational direction with respect to said first axis of said swivel hinge.

In said second closed position said first housing element and said second housing element are folded together until the second face and said third face are conformingly adjacent to each other, such that said first user interface is accessible on an outer side of foldable cellular phone device.

The device of the present invention further comprises an earpiece (with an earpiece loudspeaker) that is arranged in said second housing element. The earpiece is provided with a sound outlet that is located at said third face.

Said first housing element is provided with a soundhole, wherein said soundhole is arranged such that in said second closed position said sound hole is located oppositely to said earpiece in said second housing element. The soundhole is arranged such that an audio signal generated by said earpiece is passing through said soundhole and through said first housing element.

It is to be noted that said earpiece (or the acoustic output of said earpiece loudspeaker) is arranged in the third face of the second housing element, in the area that is covered by the first housing element when the device is in the closed position.

The present invention provides a foldable cellular phone device wherein the device can comprise a large display with a touch pad wherein the display unit (i.e. the first user interface) could be used in different ways. The device can be used e.g. in PDA mode, wherein the display is located and/or oriented outside when the unit is closed, a game mode, wherein the display is located inside and the unit is folded open, and a protected mode, wherein the display is inside (not visible) and the unit is closed. One independent claim covers the usage of an earpiece in the body element, by passing or conducting acoustic signals through a soundhole (or acoustic duct) in the cover element.

Said foldable cellular phone device can provide a handheld-electronic device functionality such as a PDA, a handheld computer comprising implementations such as e.g. a tablet mode enabled laptop or a palmtop with flip-fold or flip-swivel display.

In another example embodiment of said foldable cellular phone device said first user interface comprises a touch-screen display. This embodiment explicitly enables a PDA mode of the foldable cellular phone device. This embodiment also enables a touch-screen telephone mode of the foldable cellular phone device in the second closed position.

In another example embodiment said foldable cellular phone device further comprises a gaming device. The embodiment provides a mobile terminal with flip/swivel display/touch-screen, which basically supports three modes:
a first mode, wherein the first element or the “flipcover” is closed and the touch-screen is turned to the outside to provide touch-screen based phone/PDA functionality (i.e. the second closed position);
a second mode with an opened flipcover, wherein the touch-screen is used as display for gaming and wherein gaming controls on the lower element are used for controlling game applications; and
a third mode, wherein the terminal is not in use and the flip is closed and the touch-screen is turned to the inside.

According to another aspect of the present invention there is provided a foldable cellular phone device with a cellular phone component having an earpiece. Said foldable cellular phone device is provided with a housing having a first and a second element connected or articulated via a flip-swivel hinge. The first housing element has a first and a second face. The second housing element has a third and a fourth face. A first user interface is mounted within said first housing element and is accessible on said first face. A second user interface is mounted within said second housing element and is accessible on said third face. Said first housing element and said second housing element are coupled together by a swivel hinge, such that said first housing element and said second housing element can rotate about a first axis of said swivel hinge between a first closed position and a first open position.

In said first closed position said first housing element and said second housing element are folded together such that the first face and said third face are conformingly adjacent to each other enclosing said first user interface and said second user interface in-between said first housing element and said second housing element.

In said first open position said first housing element and said second housing element are folded open with said first and said second housing elements being angularly displaced about said first axis from said first closed position to an angle between 90 and 180 degrees such that said first and said third face are arranged oppositely. In the first open position first and second user interfaces are arranged as the inner sides of covers of an open book, facing each other.

Said swivel hinge further couples said first housing element and said second housing element such that said first housing element can rotate about a second axis of said swivel hinge perpendicular to said first axis. The first housing element can be rotated between a first rotation position and a second rotation position, relative to said second housing element.

In said first open position and said first closed position said first element is in said first rotation position.

Said foldable cellular phone device further comprises a second open position and a second closed position, wherein said first element is in said second rotation position.

In said second open position said first housing element and said second housing element are folded open with said first and said second housing elements being angularly displaced about said first axis from said first closed position to an angle between 90 and 180 degrees such that said second and said third face are arranged oppositely. In the second open position said first and second user interfaces are facing in the same rotational direction with respect to said first axis of said swivel hinge.

In said second closed position said first housing element and said second housing element are folded together until the second face and said third face are conformingly adjacent to each other, such that said first user interface is accessible on an outer side of said foldable cellular phone device.

Said first user interface comprises a touch screen display, and said second user interface comprises game input interfaces.

That is said foldable cellular phone device comprises a gaming device with a touch screen display and game input interfaces. The embodiment provides a mobile terminal with flip/swivel display/touch-screen, which basically supports three modes: A first mode, wherein the flipcover is closed and the touch-screen is turned to the outside to provide touch-screen based phone/PDA functionality (i.e. the second closed position); a second mode with an opened flipcover, wherein the touch-screen is used as display for gaming and wherein gaming controls on the lower flip are used for controlling game applications; and a third mode, wherein the terminal is not in use and the flip is closed and the touch-screen is turned to the inside.

It is to be noted that the expression “cellular phone” has been selected to encompass all kinds of wireless telephony applications, such as wireless telephones, cellular telephones (GSM, UMTS, etc.) and also satellite based telephony communication devices that are actually not based on “cells”.

In another example embodiment of the present invention said earpiece is arranged in said second housing element, and said first housing element is provided with a soundhole, wherein said soundhole is arranged such that in said second closed position said sound hole is located oppositely to said earpiece in said second housing element such that an audio signal generated by said earpiece is transmitted through said first housing element.

In an example embodiment of the present invention said foldable cellular phone device further comprises a second soundhole arranged on said first housing element. Said second soundhole is arranged in the first housing element such that in said first closed position said sound hole is located oppositely to said earpiece in said second housing element such that an audio signal generated by said earpiece is carried through said first housing element. That is in both closed positions a sound hold can duct acoustic waves through the first housing element. That is, this embodiment of the present invention provides e.g. a phone concept that comprises a swivel display and enables e.g. a phone functionality in each available position of a closed display unit. It may be noted that in this embodiment the (first) soundhole and the second soundhole can be shaped basically in the same optimized way to guide as much sound energy as possible through the first housing element. Due the structure of the folding operation the soundholes are not expected to be symmetrically shaped but to comprise a sound inlet and a sound outlet to be able to conduct as much acoustic energy as possible from the inlet to said outlet. It is expected that in this embodiment of the present invention the main transport direction of the first soundhole is from the second face to the first face of the first housing element, whereas the main transport direction of the second soundhole is vice versa from the first face to the second face of the first housing element. That is, the acoustic transport direction of the second soundhole is directed oppositely to the acoustic transport direction of the first soundhole.

The earpiece is placed in the second housing element of the main body. The second housing element or display unit has no active earpiece component but only a passive soundhole or duct from main body to the sound outlet. The sound outlet of the soundhole can be connected to recesses. The dummy microphone can be embodied as just a slit. In case of an electronic device that also comprises a telephone this embodiment can also be used to take an incoming telephone call in both the first closed position and the second closed position. If voice dialing is enabled it is also envisaged to make phone calls in both closed positions.

In another example embodiment of said foldable cellular phone device said game input interfaces comprise action keys and at least one joystick. The joystick can be embodied as a fat joypad or “steering cross” to enable a simple folding operation. The joystick can be embodied or accompanied by a touch sensitive area for a left or the right hand. The joystick can also be implemented or accompanied by a trackball. It is envisaged to implement the action keys as a 12 key ITU-T keyboard that may be provided with special marked multifunctional action keys. The gaming interface can comprise e.g. action keys, joysticks, joypads, trackballs, rocker keys, sliding input interfaces, touchpads, buttons, tumblers, toggle switches, steering wheels and/or bistable switches etc.

In yet another example embodiment said foldable cellular phone device further comprises shoulder keys provided in the second housing element at the same side said swivel hinge is arranged on.

The present invention can provide a combination of a gaming terminal and a mobile telephone provided with game control buttons in the second housing element that can be accessed in the first open position for controlling a game application. In this first open position a user can follow the game on the big display in the upper portion, as known from clamshell gaming devices. The user can also use at least two additional game keys (shoulder keys) provided at the upper side of the second element, i.e. the side the first housing element is hinged to the second housing element. It is envisaged to add additional “shoulder keys” that can be arranged on one side face of the second element, or on the side faces of the second element. It is also contemplated to locate additional shoulder keys at the first face or the side faces of the first element to provide additional input interfaces to the device. Shoulder keys may also be accessed in the closed position. Shoulder keys enable a user to use the fingers that hold the device for game input.

The foldable cellular phone device can comprise two different closed positions. In the first closed position the display is facing to the inner side of the closed clamshell. In this configuration it can be possible to take incoming telephone calls by pressing e.g. one of the shoulder keys or other keys accessible in the first closed position. The call accepting keys may be located at the ends or the side faces of the foldable cellular phone device. The “call accepting keys” can also be located on said second or said fourth face.

Yet another additional example embodiment of the foldable cellular phone device is further provided with a display on the side face of the housing. This display can be located between the shoulder keys to indicate a calling number (or the name of a caller) in case of an incoming phone call in the first closed position. In this case the display is located at the side the hinge is located at. It is also possible to locate the display at the short side of the end of the (first or second) element to rapidly recognize a number of a calling party when the phone device is inserted in abreast pocked and the narrow side visible from above.

In another example embodiment of said foldable cellular phone device, the cavity of the soundhole through the first housing element has a volume such that the soundhole can act as a resonator. That is, the sound output of the earpiece in the main body is ducted through the display unit, using a channel inside the display unit as resonator. The resonator cavity of the soundhole (or the complete acoustic path from the loudspeaker of the earpiece through the earpiece outlet, via a sealed gap and the soundhole) can be tuned to the frequency band of the human voice. It is also contemplated to shape the resonator in a way to match the transmission characteristics of the voice channel of cellular telephone voice transmissions.

In yet another example embodiment of said foldable cellular phone device the soundhole is provided with a substantially funnel-like shape, i.e. the shape of a horn or a bell as known from gramophones or trumpets. This funnel structure can be applied on one hand to collect the acoustic signal emerging from the earpiece outlet and can on the other hand be used to generate a desired acoustic emission characteristic on the output side of the sound hole.

In another example embodiment of said foldable cellular phone device said soundhole comprises multiple recesses at the sound outlet. By using multiple recesses it is possible to reduce the diameter of each single recess, reducing the risk of occlusions of the soundholes. The multiple recesses in the display unit can optically indicate the “earpiece area” of a telephone device. It is also envisaged to use the multiple recesses to generate an especially designed acoustic emission characteristic adapted to the sound collecting properties of an averaged human outer ear or auricle.

In yet another example embodiment of said foldable cellular phone device said soundhole comprises only one inlet. This inlet can be adapted to the outlet of the earpiece in the second housing element. The single inlet opening can serve as a microphone dummy, to indicate to a user the right orientation of the mobile phone.

In another example embodiment said foldable cellular phone device further comprises a sealing component arranged such that the sealing seals the gap between an outlet of the earpiece and the inlet of the soundhole.

One sealing is disposed in the second element near the outlet of the earpiece and therefore can seal the gap between the first and the second housing elements in both closed positions of the device.

Two sealing components can be disposed in the first element each one on the first and on the second side each around the inlet of the soundholes so they each can seal the gap between the first and the second housing elements in both closed positions.

In still another example embodiment said foldable cellular phone device further comprises a microphone being arranged in the second housing element. The microphone and the microphone inlet may be arranged e.g. at a side face of a substantially block or brick shaped second housing element. It is also envisaged to place the microphone at an end face of the second housing element or at the side at the side of the hinge at or at the side opposite to the hinge or the shoulder keys.

In the following the invention will be described in detail by referring to the enclosed drawings.

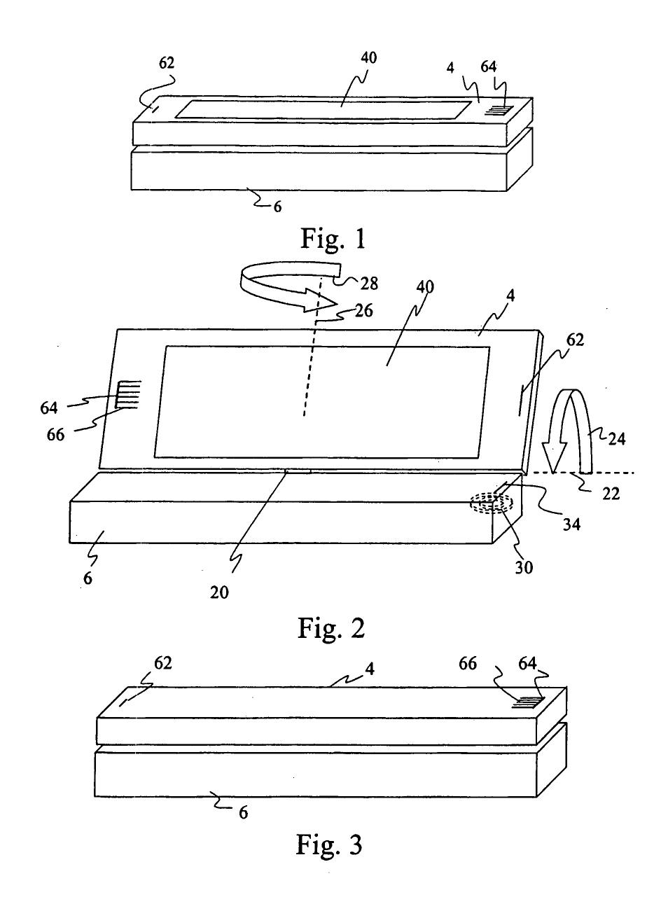

FIG. 1 is an example of a schematic foldable cellular phone device in a second closed position.

FIG. 2 shows the foldable cellular phone device in a palmtop or game mode or the first open position.

FIG. 3 depicts an embodiment of the foldable cellular phone device of the present invention in the first closed position.

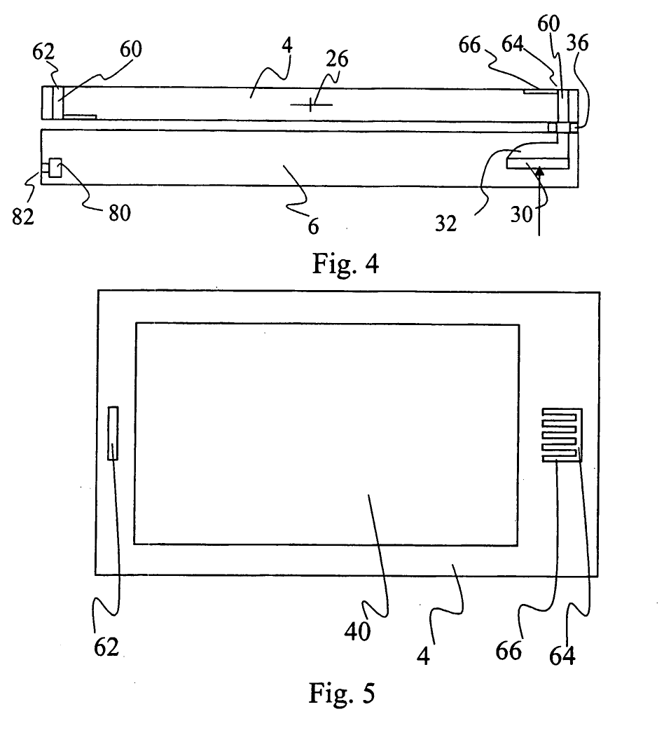

FIG. 4 is a cross section cut of the foldable cellular phone device in one of the closed positions.

FIG. 5 shows a top view of an embodiment of the foldable cellular phone device of the present invention in the second closed position.

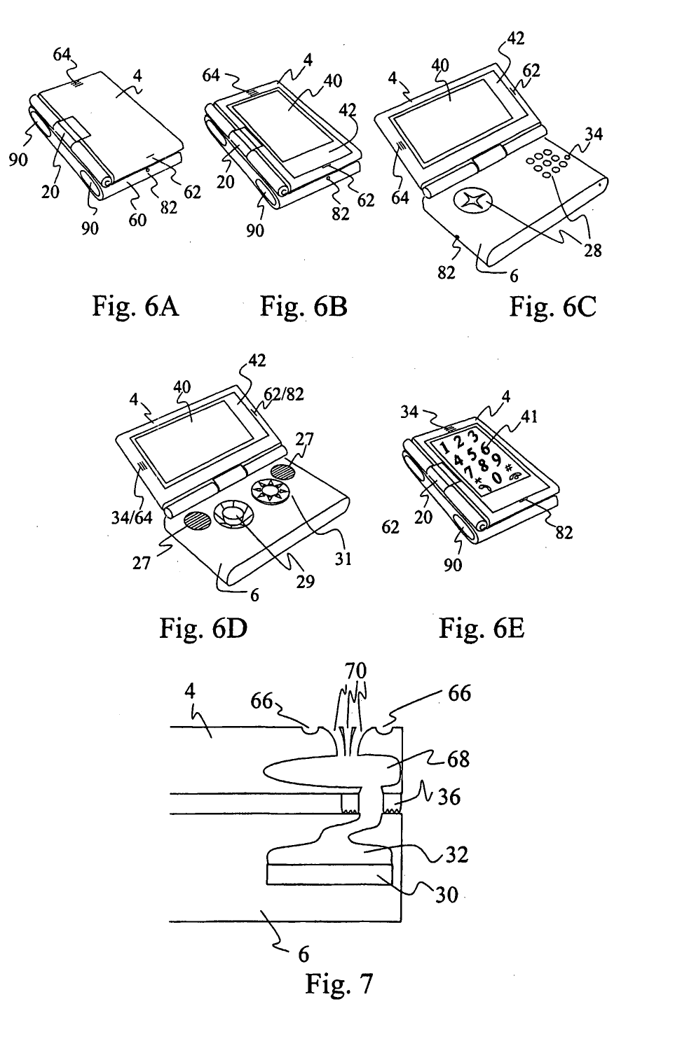

FIGS. 6A to 6E show perspective views of a cellular game telephone device of two additional example embodiments according to the present invention.

FIG. 7 shows a cross sectional view of the acoustic path of a soundhole in a more sophisticated embodiment with a resonance chamber and outlet horns.

It is to be noted that in the text and in the figures same reference signs are used to refer to same ore similar objects or elements.

FIG. 1 shows a schematic outer view of the foldable cellular phone device according to a first embodiment of the present invention, in a second closed position. In FIG. 1 the foldable cellular phone device is in the second closed position or in the PDA-mode. FIG. 1 depicts a foldable cellular phone device with a main body or first housing element 4 and the display unit or second housing element 6. The first housing element 4 is provided with a display 40 on the first face of the first housing element 4. The first housing element 4 is further provided with a dummy microphone 62, and with an earpiece outlet 64.

FIG. 2 shows the foldable cellular phone device in a “games mode” or a “laptop mode” i.e. the first open position. The display 40 is located inside. The first housing element 4 is hingedly connected or articulated to the second housing element 6 via a flip-swivel hinge 20. The hinge 20 enables the first housing element 4 to be moved around a first clamshell axis 22 as known from foldable phones and foldable gaming devices. The hinge 20 additionally allows a movement of the first housing element 4 around an axis 26 perpendicular to the clamshell axis 22. The first housing element 4 can be moved in the direction 28 around the swivel axis 26 to determine if the display is located on the inside or on the outside when the foldable cellular phone device is closed subsequently in the “clamshell movement” direction 24.

The dummy microphone 62 and the sound outlet 64 with recesses 66 have changed the sides with respect to FIG. 1, as the first housing element 4 has been turned over in direction 28 around the swivel axis 26. In FIG. 2 there is also indicated an earpiece 30 and a sound outlet 32. It is to be noted that the sound outlet is located oppositely to the dummy microphone 62. The earpiece outlet 64 is provided with recesses 66. In the depicted position the visible earpiece outlet 64 can not be used.

FIG. 3 depicts an embodiment of the present invention in the first closed position. The foldable cellular phone device of FIG. 3 has been closed around the clamshell axis 22. The only visible difference to FIG. 1 resides in that the display is not visible, as it faces towards the second housing element 6. The depicted dummy microphone inlet 62 and the earpiece outlet 64 with the recesses 66 correspond to the respective elements beside the display 40 (not visible)

FIG. 4 is a cross sectional cut of the foldable cellular phone device in one of the closed positions. FIG. 4 indicates a possible position for a real microphone at an end portion of the second housing element 6 provided with a sound inlet 82. The earpiece transducer 30 is located in the second housing element 6. The transducer 30 is acoustically connected via the front cavity 32 to the sound outlet or transducer outlet 34 (not provided with a reference sign in FIG. 4). A sealing gasket 36 is provided to seal the acoustic connection of the sound outlet 34 to the dummy microphone inlet 62 of the soundhole 60 on the right side of FIG. 4. A sound generated by the transducer is directed through the front cavity with the sealed gap, through the sound hole to the earpiece outlet 64. Thus, a user can hear at the earpiece outlet 64 the sound generated by the transducer 30 in the second housing element 6 through the soundhole 60 provided in the first housing element. The cross 26 indicates the axis perpendicular to the plane of figure of a 180° degrees rotational symmetry of the sound holes of the left and of the right sides. It is to be noted that a second gasket may be provided at the dummy microphone section of the sound hole at the left side.

FIG. 5 shows a top view of an embodiment of the present invention in the second closed position, with the same features as already disclosed in FIG. 1.

FIG. 6A shows another embodiment of the present invention in the first closed position. In addition to the embodiments shown in FIGS. 1 to 5 the foldable cellular phone device is provided with shoulder keys 90. In the depicted closed position an incoming telephone call can be accepted e.g. by pressing one of the shoulder keys.

FIG. 6B shows the embodiment of FIG. 6A in the second closed position in a monoblock/phone mode. The shoulder keys 90 and the display 40 with the touch sensitive field 42 are depicted. In this configuration the foldable cellular phone device can be used as a touch-screen telephone or as a PDA. In the second closed position the display can be operated in portrait mode or in an upright format. It can be possible to change the display to landscape format in this operation mode to watch a video sequence or a video stream. In the monoblock mode the input can be performed e.g. by a “touch-screen stylus” or “touch-screen pen” and additionally by the shoulder keys.

FIG. 6C shows the embodiment of FIGS. 6A and 6B in the first open position. The game input interface 28 at the third face comprises input keys, a control pad (e.g. a kind of “flat joystick”) and the transducer outlet 34. On the display 40 the touch sensitive field 42 is depicted. In the first open position the display can be operated in landscape format. In the first open position of the terminal the touch-screen can be used as a display for gaming and the gaming controls can be accessed easily by the game player.

FIG. 6D shows the embodiment of FIG. 6B in the first open position. In contrast to the embodiment of FIG. 6C the embodiment of FIG. 6D is provided with differently designed game interfaces. The game interface comprises at the left side a joystick 29. On the right side an 8-direction rocker key 31 is arranged. This gaming interface may better suit the requirements of modem action games. The gaming interface of the embodiment of FIG. 6D is further completed by a set of stereo loudspeakers 27 arranged at the left side and on the right side of the game input interfaces 27 and 31. Different and game interfaces such as sliding input interfaces, touchpads, trackballs, buttons, tumblers, toggle switches, steering wheels and/or bistable switches may also be implemented in the game input interface. It is also possible to implement feedback game input interfaces, such as joysticks and steering wheels. In the first open position of the terminal the touch-screen can be used as a display for gaming and the gaming controls can be accessed easily by the game player.

It is to be noted that the embodiment of FIG. 6D may also be provided with an earpiece transducer and an earpiece outlet 34 and a real microphone with a sound inlet 82 at the end portions of the first housing element 4. In this case the embodiment of FIG. 6D may not be provided with an earpiece outlet 64 and a dummy microphone 62 on the backside of the first housing element 4 as indicated e.g. in FIG. 6A.

It is also envisaged to provide the earpiece transducer outlet 34 and the microphone with a sound inlet 82 at the end portions of the housing element 6, as depicted in FIG. 6C. In this case the embodiment of FIG. 6D may also be provided with an earpiece outlet 64 and a dummy microphone 62 on the backside of the first housing element 4 as indicated in FIG. 6A.

FIG. 6E shows the embodiment of FIG. 6B in the monoblock/phone mode. The shoulder keys 90 and the display 40 with the touch sensitive field 42 are depicted. The touch screen display emulates an ITU-T keyboard that can be used to enter telephone number. At the left bottom side an right bottom side of the touch screen display two icons are depicted for picking up the pieces and to hang up the telephone. It is also contemplated to depict the conventional display contents such as e.g. dialed telephone number, actual telephone time, battery power, signal strength, custom background graphics, additional information to dialed/received numbers and the like. In the monoblock mode the input can be performed e.g. by a “finger”, a “touch-screen stylus” or “touch-screen pen” and additionally by the shoulder keys 90. It is also possible to implement different user selectable display options such as big icons, video phone and the like.

FIG. 7 shows a cross sectional view of the acoustic path in a more sophisticated embodiment of the present invention. The acoustic path is divided in two parts, one in the second housing element 4, and the other in the first housing element 6. The soundhole of FIG. 7 is provided with a resonance chamber 68 in the first housing element 4 and with outlet horns 70 to direct the sound emerging from the soundhole 60 to the ear of a user. The sealing gasket 36 is provided with a sealing structure at the contact surface to the second housing element. Additionally, the front cavity 32 has been reshaped to generate acoustic weaves at the transducer outlet 34 directed to the dummy microphone, i.e. the sound inlet of the soundhole 60. The volumes of the front cavity 32 and the resonance chamber 68 can be selected to generate a desired frequency transmission characteristic preferably tuned to the frequency band of the human voice for a suitable maximal telephone operability.

With the invention an easy to implement earpiece solution for swivel display phones that enables earpiece use irrespective of the display unit position (here first closed and second closed positions) is provided. The visible recesses clearly indicate the earpiece sound outlets and distinguish them from (potentially) un-used earpiece duct and microphone. The recesses at the earpiece sound outlet prevent the sound outlet from being occluded by the ear.

With the invention an easy to use cellular game phone solution is provided to enable the implementation of a big display in a foldable gaming device with a satisfying usability of the cellular telephone component.

The solution of the present invention provides full earpiece functionality no matter in which direction the display unit is closed.

Compared to a solution wherein a transducer is placed within the display unit, the present invention provides the following advantages:
no electrical audio signal routing through the hinge is necessary,
the microphone can be placed near the audio processing means;
earpiece openings and sound transducers are not necessary on both sides of the display unit for swivel use,
the design need not to be adapted as the foldable cellular phone device (microphone and earpiece) does not need to be turned around 180° depending on the mode,
The number of visible gaskets to seal the resonating system from emitting an audio signal in the gap between the two elements can be reduced,

The foldable cellular phone device in accordance with the present invention has the following benefits:
short audio routing, which is better protected against insulation risks,
the ability to place sensitive transducers in the main body, and that no active acoustical components need to be placed in the display unit,
not changing the location of the earpiece when the display unit is flipped, providing same acoustic conditions for both modes,
emitting the antenna radiation in a direction that is in the opposite direction of the sound outlet direction of the earpiece,
requiring only one visible gasket at the main body to seal the audio channel from the earpiece to the display unit. Depending on the mode one certain duct will be placed over the earpiece outlet sealed by the gasket.

Possible losses caused by a long duct of the earpiece outlet and the soundhole may be balanced by an increased diameter or by designing the soundhole as an acoustic resonator.

The present invention can be applied to all kinds of swivel top foldable phones with earpieces that can be used for conducting a telephone call in a closed position.

Although the second face of the first housing element and the fourth face of the second housing element have not been described in detail it is explicitly noted that on these faces additional interfaces may be implemented.

This application contains the description of implementations and embodiments of the present invention with the help of examples. A person skilled in the art will appreciate that the present invention is not restricted to details of the embodiments presented above, and that the invention can also be implemented in another form without deviating from the characteristics of the invention. The embodiments presented above should be considered illustrative, but not restricting. Thus the possibilities of implementing and using the invention are only restricted by the enclosed claims. Consequently various options of implementing the invention as determined by the claims, including equivalent implementations, also belong to the scope of the invention.

1. Foldable cellular phone device with a cellular phone component, provided with an earpiece, said foldable cellular phone device comprising a housing having:
a first housing element, having first and second faces; and
a second housing element having third and fourth faces;
wherein a first user interface is mounted within said first housing element and is accessible on said first face;
wherein a second user interface is mounted within said second housing element and is accessible on said third face;
wherein said first housing element and said second housing element are coupled together by a swivel hinge, such that said first housing element and said second housing element can rotate about a first axis of said swivel hinge between a first closed position and a first open position,
wherein in said first closed position said first housing element and said second housing element are folded together such that the first face and said third face are conformingly adjacent to each other enclosing said first user interface and said second user interface between said first housing element and said second housing element, and
wherein in said first open position said first housing element and said second housing element are folded open with said first and said second housing elements being angularly displaced about said first axis from said first closed position to an angle between 90 and 180 degrees such that said first and said third face are arranged oppositely,
wherein said swivel hinge further couples said first housing element and said second housing element such that said first housing element can rotate about a second axis of said swivel hinge perpendicular to said first axis between a first rotation position and a second rotation position of said first housing element, as defined relative to said second housing element,
wherein in said first open position and said first closed position said first element is in said first rotation position, and
wherein said foldable cellular phone device further comprises a second open position and a second closed position, wherein said first element is in said second rotation position,
wherein in said second open position said first housing element and said second housing element are folded open with said first and said second housing elements being angularly displaced about said first axis from said first closed position to an angle between 90 and 180 degrees such that said such that said second and said third face are arranged oppositely, and
wherein in said second closed position said first housing element and said second housing element are folded together such that the second face and said third face are conformingly adjacent to each other, such that said first user interface is accessible on an outer side of said foldable cellular phone device,
wherein said earpiece is arranged in said second housing element wherein a sound outlet of said earpiece is located at said third face,
said first housing element is provided with a sound hole, wherein said sound hole is arranged such that in said second closed position said sound hole is located oppositely to said sound outlet of said earpiece in said second housing element such that an audio signal generated by said earpiece is transmitted through said first housing element, and
said first housing element further comprises a second sound hole arranged on said first housing element such that said second sound hole is arranged in a way such that in said first closed position said second sound hole is located oppositely to said earpiece in said second housing element such that an audio signal generated by said earpiece is transmitted through said first housing element.

2. Foldable cellular phone device according to claim 1, wherein said first user interface comprises a touch-screen display.

3. Foldable cellular phone device according to claim 1, further comprising a gaming device and wherein said second user interface comprises game input interfaces.

4.-6. (canceled)

7. Foldable cellular phone device according to claim 3 wherein said game input interfaces comprise action keys and at least one joystick.

8. Foldable cellular phone device according to claim 1, further comprising shoulder keys provided in the second housing element at the side said swivel hinge is arranged at.

9. Foldable cellular phone device according to claim 1, further comprising a display on the side face of the housing.

10. Foldable cellular phone device according to claim 1, wherein the cavity of the soundhole through the first housing element has a volume such that the soundhole acts as a resonator.

11. Foldable cellular phone device according to claim 1, wherein the soundhole has substantially the shape of a funnel.

12. Foldable cellular phone device according to claim 1, wherein said soundhole comprises multiple recesses at the earpiece sound outlets.

13. Foldable cellular phone device according to claim 1, wherein said soundhole comprises only one inlet.

14. Foldable cellular phone device according to claim 1, further comprising a sealing, arranged such that the sealing seals the gap between an outlet of the earpiece and the inlet of the soundhole.

15. Foldable cellular phone device according to claim 1, wherein a microphone is arranged in the second housing element.
